(19) United States
(12) Patent Application Publication
(10) Pub. No.: US 2007/0117037 A1
(43) Pub. Date: May 24, 2007

(54) Liquid developer manufacture process

(76) Inventors: Tomer Spector, Neve Monoson (IL); Nava Klein, Rishon Lezion (IL); Yaacov Almog, Nes Ziona (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/576,387

(22) PCT Filed: Oct. 26, 2003
(86) PCT No.: PCT/IL03/00879

§ 371 Date: Apr. 19, 2006

(51) Int. Cl. G03G 9/12

(52) U.S. Cl. 430/137.19; 430/137.22

(57) ABSTRACT

A method of creating a liquid developer with improved conductivity comprising: dissolving a solid charge adjuvant in a carrier liquid aided by heating the carrier liquid; then mixing the dissolved charge adjuvant with a thermoplastic resin and carrier liquid; grinding the mixture to form toner particles; and adding a charge director to charge the toner particles.

### FIELD OF THE INVENTION

The present invention relates to the process of producing liquid developers for developing electrostatic latent images.

### BACKGROUND OF THE INVENTION

In many printing systems, it is common practice to develop a hardcopy of an image by using a photo-conductive surface. The photo-conductive surface is selectively charged with a latent electrostatic image having image and background areas. A liquid developer comprising charged toner particles in a carrier liquid is brought into contact with the selectively charged photo-conductive surface. The charged toner particles adhere to the image areas of the latent image while the background areas remain clean. A hardcopy material (e.g. paper) is brought directly or indirectly into contact with the photo-conductive surface in order to transfer the latent image.

Typically the liquid developer comprises a thermoplastic resin (polymer) as the basis for the toner particles, and a non-polar liquid is used as the carrier liquid in which the toner particles are dispersed. Generally, the toner particles contain a colorant such as a pigment.

A charge director is also added to the dispersion to induce charge on the particles. As known in the art, a charge adjuvant may be added to increase the charging effect of the charge director.

U.S. Pat. No. 4,707,429, the disclosure of which is incorporated herein by reference, describes materials and processes for preparing a liquid developer using an aluminum stearate charge adjuvant.

U.S. Pat. No. 5,565,299, the disclosure of which is incorporated herein by reference, describes materials and processes for preparing a liquid developer.

U.S. Pat. No. 5,573,882, the disclosure of which is incorporated herein by reference, describes materials and processes for preparing a liquid developer with additional charge adjuvants.

The use of aluminum stearates as charge adjuvants is widely described in the literature. These materials are generally solid at room temperature and not soluble to any great extent in the carrier liquid used in the toner at room temperature. FIGS. 1 and 2 illustrate prior art methods of producing toner utilizing charge adjuvants.

FIG. 1 is a schematic flow diagram 100 of a method of preparing a liquid developer, as is known in the art, for example as described in U.S. Pat. No. 5,573,882. As shown in 110, a thermoplastic resin (e.g. ethylene vinyl acetate copolymers) referred to in FIG. 1 as polymer, is dispersed in a carrier liquid (e.g. Isopar-L). The mixture is placed in an appropriate sized mixing vessel (referred to herein as a mixer), with the ability of mixing the components, and heating them to a selected temperature. An example of such a mill (mixer) is a Ross double planetary mixer manufactured by Charles Ross and Son, Hauppauge, N.Y.

In an exemplary embodiment, in 110, the mixture is heated and mixed at a temperature suitable for the polymer to solvate the carrier liquid and to be thus plasticized by it, generally between 70-130° C. As the mixture cools particles of plasticized polymer are precipitated.

At 120, the material resulting from 110 is further diluted with more carrier liquid, for example with the weight of the solids used comprising 10-40% relative to the total weight of the mixture. Optional colorants such as pigment or dye are added to give the mixture a desired color. Additionally, a solid charge adjuvant is added to increase the toner chargeability. Exemplary charge adjuvants are metallic soaps such as aluminum magnesium stearate or octoate, fine particle size oxides, such as oxides of silica, alumina, titania and others known in the art. The mixture of the above ingredients is ground in a ball mill while being kept at a relatively low temperature, such as 40-60° C., until particles of a desired dimension and forming a uniform liquid with a desired particle density.

At 130, after the mixture is cooled, a liquid or liquid soluble charge director is added to increase the charge of the toner particles. Additionally, more carrier liquid may be added to reach a final solids density (e.g. with the weight of the solids being 10-20% of the mixture). The mixture is diluted with additional carrier liquid to form a liquid toner. Generally, the solids content of the toner is 1-2% by weight.

FIG. 2 is a schematic flow diagram 200 of second general method of preparing liquid developer as is known in the art, for example as described in U.S. Pat. No. 5,565,299 At 210 the polymer, carrier liquid and charge adjuvant are heated and mixed. The process of 210 is similar to that of 110 (of FIG. 1) except that the charge adjuvant is added at this stage. The reference describes the use of aluminium stearate and imine bisquinone as charge adjuvants.

At 220, the mixture is further diluted with carrier liquid and placed in a ball mill and ground as in 120 of FIG. 1.

At 230, toner is charged and diluted as in 130.

Also known in the art is a variant of the general methods described with respect to FIGS. 1 and 2. In FIGS. 1 and 2, the polymer is first mixed with and plasticized by the carrier liquid at a high temperature and then cooled and transferred to a grinder for grinding at a lower temperature. In the variant method, the ingredients are placed in a grinder and the plasticization takes place in the grinder. Then the mixture is cooled and grinding continues at the lower temperature to form the toner particles. For the purposes of the present invention, there is not believed to be any difference between the methods.

The US patents incorporated by reference in the background of the description supply further details regarding preparation of liquid developers as is known in the art.

### SUMMARY OF THE INVENTION

An aspect of some embodiments of the invention, relates to a method of creating a liquid developer from specific ingredients, wherein the chargeability of the toner particles is improved over prior art methods created from the same ingredients.

In some embodiments of the invention, a solid charge adjuvant is dissolved in a carrier liquid to form a charge adjuvant solution. For aluminum tristearate, the sold material dissolves in the carrier liquid at 130° C. However, it remains dissolved at 40-60° C. and remains active under certain conditions.

In one embodiment of invention, the charge adjuvant solution is added to the solvated polymer mixture during grinding, as in the first method described above. In a second embodiment of the invention, the charge adjuvant solution is added to polymer/carrier liquid is added at the mixing/plasticizing stage.

In both embodiments, the chargeability is improved over the standard methods and the amount of grinding required to achieve the chargeability is also reduced significantly.

While in the prior art described above, the charge adjuvant is added to the mixture (at whatever time it is added) in solid form, in exemplary embodiments of the invention, it is added to the mixture in solution. Optionally, the solution is at a temperature at which the solid charge adjuvant has limited solubility or does not dissolve at all. However, the charge adjuvant remains dissolved at this lower temperature after being dissolved at the higher temperature. In the present context, limited solubility refers to solubility of an amount of adjuvant that is lower than that needed for desired charging of the toner particles.

There is thus provided, in accordance with an embodiment of the invention, a method of creating a liquid developer with improved conductivity comprising:

dissolving a solid charge adjuvant in a carrier liquid aided by heating the carrier liquid;

then mixing the dissolved charge adjuvant with a thermoplastic resin and carrier liquid;

grinding the mixture to form toner particles; and

adding a charge director to charge the toner particles.

In an embodiment of the invention, mixing and grinding comprises:

mixing the thermoplastic resin with carrier liquid;

heating the mixture of carrier liquid and thermoplastic resin to plasticize the resin;

cooling the plasticized resin;

adding the dissolved charged adjuvant to the cooled plasticized resin;

grinding the mixture of charge adjuvant and plasticized resin to form toner particles.

Alternatively or additionally, mixing and grinding comprises:

mixing the thermoplastic resin with carrier liquid and dissolved charged adjuvant at an elevated temperature;

cooling the mixture;

grinding the cooled mixture to form toner particles.

Optionally, the method includes adding a colorant, optionally a pigment.

In an embodiment of the invention, the charge adjuvant is a metallic soap, optionally an aluminum soap, optionally aluminum stearate

Optionally, the aluminum stearate comprises aluminum tri-stearate.

In an embodiment of the invention, dissolving is aided by heating to a temperature exceeding 120° C., optionally to a temperature exceeding 130° C., optionally to a temperature of no greater than 130° C.

In an embodiment of the invention, the method includes cooling the dissolved charge adjuvant to a temperature below 60° C., prior to mixing it with the polymer.

Optionally, the charge adjuvant has only limited solubility in the carrier liquid at 25° C. or is substantially insoluble in the carrier liquid at 25° C.

In an embodiment of the invention, the charge adjuvant does not dissolve in the carrier liquid at a temperature at which it is mixed with the polymer, but remains dissolved therein, when dissolved therein at said mixing temperature, when dissolved at a higher temperature.

Optionally, the charge adjuvant does not substantially dissolve in the carrier liquid at 40° or at 60°, but remains dissolved therein, when dissolved at a higher temperature.

Optionally, dissolving includes adding a surfactant to the solution of carrier liquid and charge adjuvant.

Optionally, mixing and grinding are performed in a same vessel.

Optionally, mixing and grinding are performed in a grinder or an attritor.

Optionally, mixing is performed in a first vessel and wherein said grinding is performed in a second vessel. Optionally, mixing is performed in a mixer without grinding media.

Optionally, grinding is performed in a grinder or an attritor.

### BRIEF DESCRIPTION OF THE DRAWINGS

Particular non-limiting embodiments of the invention will be described with reference to the following description of embodiments in conjunction with the figures. Identical structures, elements or parts which appear in more than one figure are generally labeled with a same or similar number in all the figures in which they appear, in which:

FIG. 1 is a schematic flow diagram of a method of preparing liquid developer as is known in the art;

FIG. 2 is a schematic flow diagram of an alternative method of preparing liquid developer as is known in the art;

FIG. 3 is a schematic flow diagram of a method of preparing liquid developer according to an exemplary embodiment of the invention;

FIG. 4 is a schematic flow diagram of an alternative method of preparing liquid developer according to an exemplary embodiment of the invention; and

FIG. 5 is a schematic graph illustrating particle conductivity relative to grinding time according to various methods of preparing liquid developer.

### DETAILED DESCRIPTION OF EXEMPLARY EMBODIMENTS

In the following description, various general methods of producing liquid developer are described. Conductivity of the resulting liquid developers are compared in order to illustrate the enhancement of the method of the invention in contrast to prior methods.

Charging of toner particles in a liquid toner is a complex process. Where the toner polymer has carboxyl moities, charging is believed to comprise disassociation of the hydrogen from the moity to leave negatively charged COO. In general, most polymers do not charge easily, since the bond is not easily broken. To aid this charging, a charge adjuvant is generally incorporated in the toner particles.

The adjuvant is believed to react with the COOH to replace the H with part of the adjuvant. This part is more loosely bonded to the COO than the H (or is more reactive with the charge director), so that better charging is achieved. Another possible method of charging is that the charge director itself disassociates and a charged portion of the charge director attaches itself to the polymer. The charge adjuvant provides bonding sites for the attachment of the charge director portion.

These theories of charging are not mean to be definitive and are not meant to limit the scope or definition of the invention. One or both of these processes may operate in any particular situation and other possibilities for charging are also possible. These possibilities are mooted to provide a possible understanding of the operation of the present invention.

Introduction of the charge director in solution is believed to provide improved reaction of the adjuvant with the carboxyl moities, resulting in better charging by the charge director.

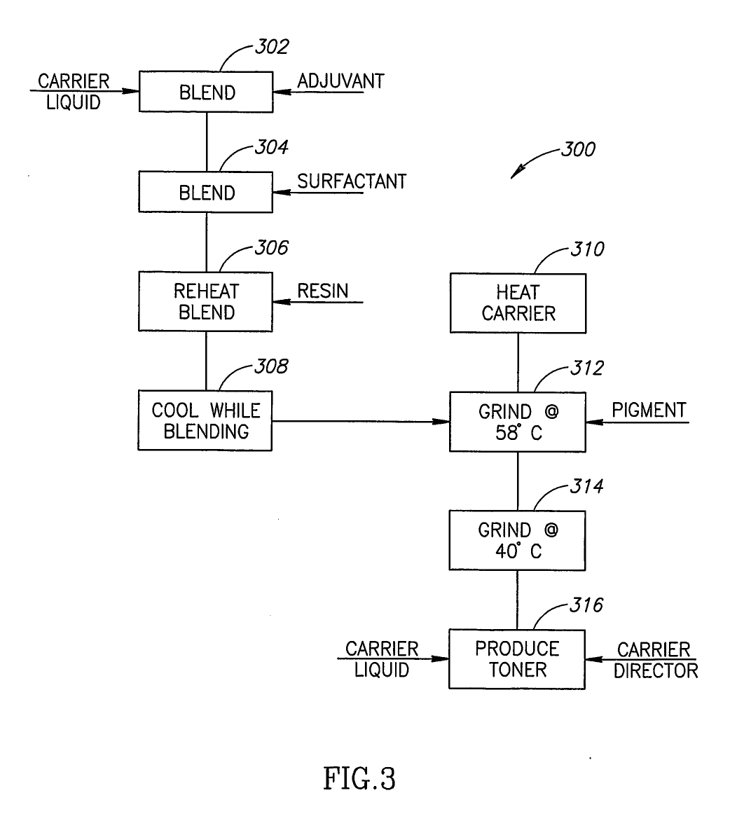

Experiment A—FIG. 3 is a schematic flow diagram 300 of a method of preparing liquid developer according to an exemplary embodiment of the invention. In an exemplary embodiment of the invention, a charge adjuvant such as aluminum tri-stearate is dissolved in a carrier liquid (e.g. a hydrocarbon liquid such as Isopar-L) by heating the mixture to a relatively high temperature, such 130° C., at which temperature the aluminum tri-stearate dissolves (302). In an exemplary embodiment of the invention, the charge adjuvant is dissolved in the carrier liquid in a mixer, for use in the following steps. In an exemplary embodiment of the invention, mixer is a Ross planetary mixer. In an experiment, 6.67 gm of aluminum tri-stereate was dissolved in 1989 gm of Isopar L (a isoparaphinic hydrocarbon liquid marketed by EXXON). Surfactant (3.9 gm of a 9.5% solution of the charge director described in respect to FIG. 3 of U.S. Pat. No. 5,346,796, the disclosure of which is incorporated by reference, is conveniently used, although other surfactants are also believed to be suitable was used as a convenient surfactant) was added (304) to help keep the adjuvant dissolved when the temperature is reduced. 500 gm of Nucrel 699 (marketed by Dupont) copolymer of ethylene methacrylic acid is added (306) and the mixture is heated to 130° C. (it is cooled by the resin). The mixture was mixed for 1 hour, to blend the components well and to allow the resin to solvate the carrier liquid. The mixture was cooled to about 60° C., while mixing continued (308).

A Union Process S1 attritor containing 3/16 inch stainless steel media was preheated to 60° C. and 367.4 gm of Isopar L (310) was heated to this temperature in the attritor. 1553.3 gm of the mixture produced at 308 was added, as was 87.4 gm of Mogul L carbon black pigment (Cabot) and 17.48 gm of FB 55 blue pigment (BASF). The resultant mixture was ground at 58° C. (312) for 3 hours, at 250 rpm (constant for all the experiments), followed by additional grinding at 40° C. (314) for an additional time (up to 13 additional hours). Samples of the material were removed at various times and mixed with additional Isopar L to produce a toner having a 1.7% w/w solids content. Charge director was added in an amount that saturates the charge on the toner particles (316).

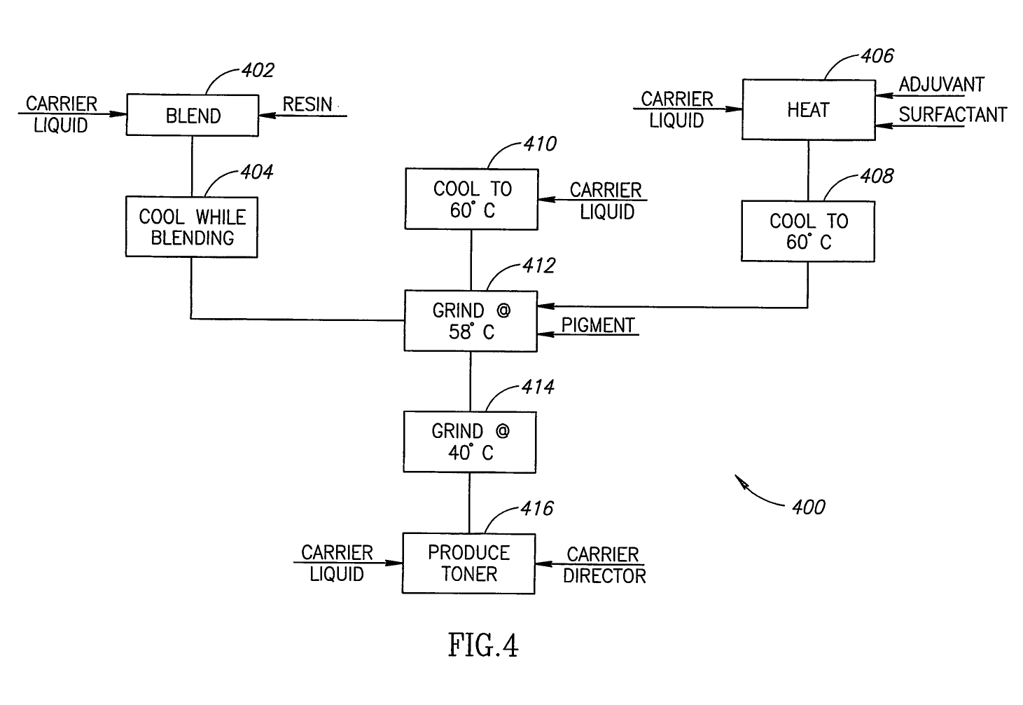

Experiment B—FIG. 4 is a schematic flow diagram 400 of a method of preparing liquid developer according to an alternative exemplary embodiment of the invention. This method differs from the previous method in that the dissolved adjuvant is added to the mix after the resin has solvated the carrier liquid, e.g., in the grinding step. Thus while in the method of FIG. 3, the dissolved adjuvant is at 130° C. when it contacts the resin, in the method of FIG. 4 it is at a much lower temperature. Nevertheless, as indicated below, the improvement in results is still present.

Isopar L and Nucrel 699 were mixed in a large planetary mixer (Mayers) at 126° C. (402) and cooled (404) while mixing continues. The proportion of Isopar-L and Nucrel provide a mixture of 23.3% solids by weight. This mixer is much larger than the Ross mixer, and is used to produce commercial quantities of the solvated resin.

A charge adjuvant such as aluminum tri-stearate was dissolved in a carrier liquid (e.g. a hydrocarbon liquid such as Isopar-L) by heating the mixture to a relatively high temperature, such 130° C., at which temperature the aluminum tri-stearate dissolves (406). In an experiment, 4.37 gm of aluminum tri-stearate was dissolved in 400 gm of Isopar L Surfactant (3.75 gm of a 9.5% solution of the charge director as in Experiment A was used as a convenient surfactant) was added to the heated mixture to help keep the adjuvant dissolved when the temperature is reduced. This process is identical to 302, 304 of FIG. 3.

The solution was cooled to 60° C. (408) at which temperature the adjuvant remained dissolved in the Isopar and remained active.

384 gm of Isopar L was heated (410) in an S1 attritor to 60° C. 1406.6 gm of the product of 304 was added, together with the pigments as in the method of FIG. 3. In all of the experiments described herein, the proportions of materials were chosen to give the same proportions, in grinding, so that the results could be directly compared. Grinding (412 and 414) and dilution and addition of carrier liquid (416) are as in Experiment A.

Three comparative batches of toner were prepared according to the prior art. In each of these the proportions of Isopar, resin, adjuvant and pigment in the grind are the same as for the previous examples. In addition, the times and temperatures are the same as in the previous examples. Similarly, charge director is added to saturation as in the above experiments.

### COMPARATIVE (PRIOR ART) EXAMPLE 1

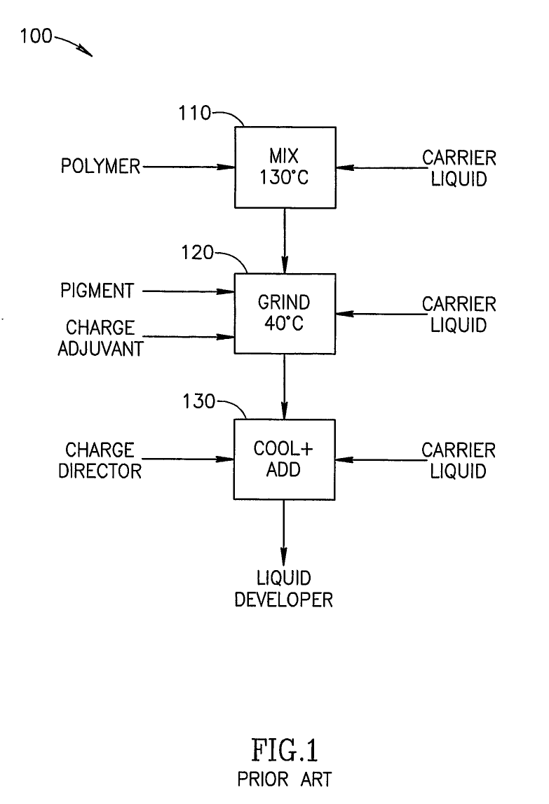

This example follows the method of FIG. 1. In this example the Isopar and resin are blended in the Ross mixer and, as in FIG. 1, the charge adjuvant is added just before grinding in solid form.

### COMPARATIVE (PRIOR ART) EXAMPLE 2

This example also follows the method of FIG. 1. It differs from comparative example 1 in that the Isopar and resin are blended in the same mixer as in Example B above.

### COMPARATIVE (PRIOR ART) EXAMPLE 3

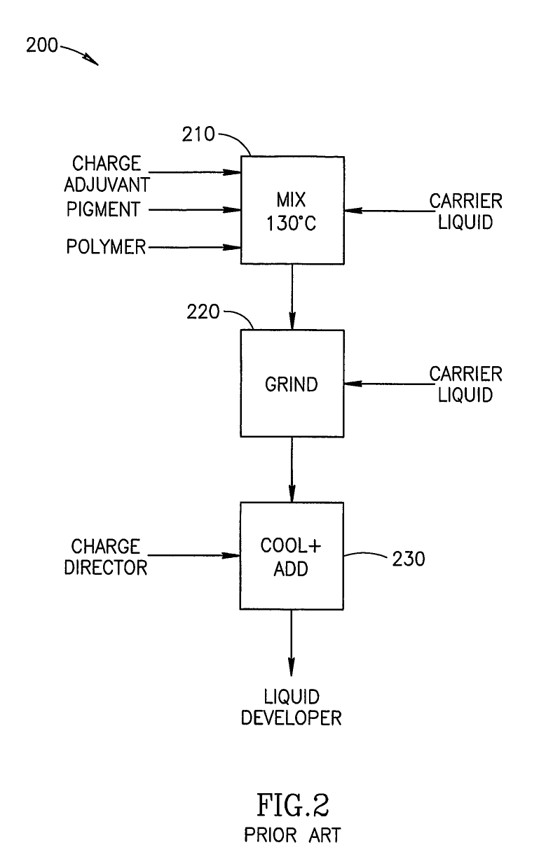

This example follows the method of FIG. 2. In this example the Isopar and resin are blended in the Ross mixer and, as in FIG. 2, the charge adjuvant is added in the blend and the pigment is added in the grinding step.

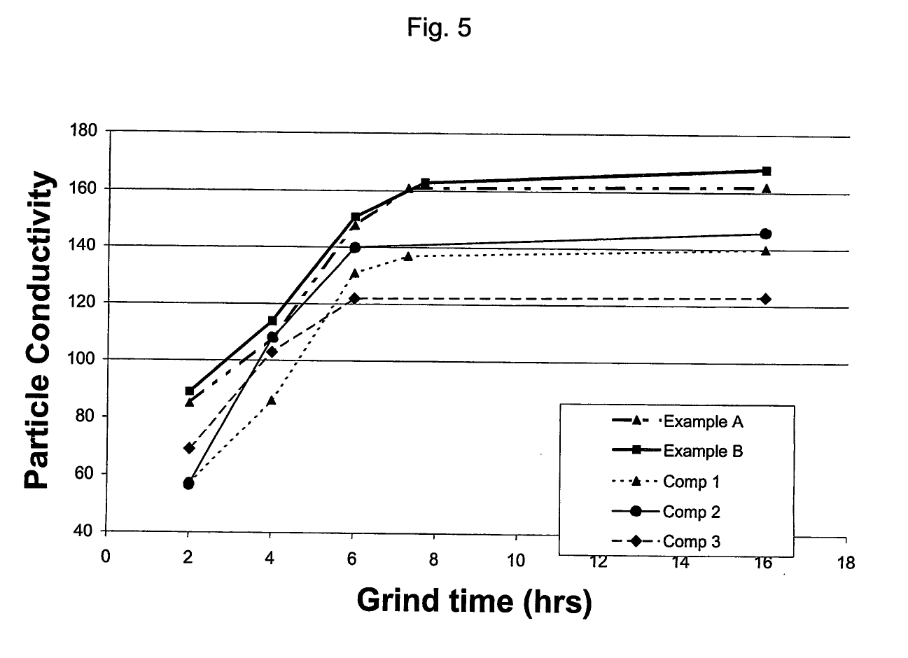

For each method a few batches were prepared using a different grinding time to allow for determining the chargeability as a function of grinding time. FIG. 5 is a graph 500 illustrating particle conductivity relative to grinding time of the various batches.

In FIG. 5 each line is marked with its respective method (A, B, 1, 2, 3) representing measurements performed on the liquid developer prepared according to the respective method described above.

As illustrated in FIG. 5 the method of flow diagram 400 based on an exemplary embodiment of the invention, results in a more conductive liquid developer. The method of flow diagram 400, which is also based on an exemplary embodiment of the invention, gives results that are slightly less conductive than the method of flow diagram 300. The prior art methods give results which are less conductive although they are comprised from the same ingredients.

An additional consequence illustrated in FIG. 5 is that for any particular required conductivity (and especially for high and more useful conductivities), the amount of grinding time is substantially shorter for the new methodologies than for the old methods.

Of course, there are other parameters of toner that are important in addition to the charging. Comparative experiments have shown that for each of these measures for which tests were made, the inventive toners are comparable to or superior to the toners produced by the old method.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments.

Variations of embodiments described will occur to persons of the art. For example, while Nucrel 699 is used in the above embodiments, other polymers can be used, for example, polymers having carboxyl moities. In addition, while the process is described for black toner, it is applicable to colored or specialty toners as well.

Furthermore, it should be understood that the method as described above has been employed to provide a clear comparison between the invention and the prior art. Thus, the performance can probably be further optimized. In addition, as is well known, the exact process parameters (times, temperatures, proportions of ingredients, etc.) are generally varied in any particular factory to optimize performance/cost of manufacture. While the invention is described with respect to aluminum tri-stearate, other aluminum stearates and aluminum compounds with limited solubility are also believed to be useful in the conduct of the invention. Other stearates, such as zinc stearate are believed to be useful in the conduct of the invention.

It is noted that some of the above described embodiments may for the reasons given above include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of creating a liquid developer with improved conductivity comprising:
dissolving a solid charge adjuvant in a carrier liquid aided by heating the carrier liquid;
then mixing the dissolved charge adjuvant with a thermoplastic resin and carrier liquid;
grinding the mixture to form toner particles; and
adding a charge director to charge the toner particles.

2. A method according to claim 1 wherein mixing and grinding comprises:
mixing the thermoplastic resin with carrier liquid;
heating the mixture of carrier liquid and thermoplastic resin to plasticize the resin;
cooling the plasticized resin;
adding the dissolved charged adjuvant to the cooled plasticized resin;
grinding the mixture of charge adjuvant and plasticized resin to form toner particles.

3. A method according to claim 1 wherein mixing and grinding comprises:
mixing the thermoplastic resin with carrier liquid and dissolved charged adjuvant at an elevated temperature;
cooling the mixture;
grinding the cooled mixture to form toner particles.

4. A method according to claim 1, comprising adding a colorant.

5. (canceled)

6. A method according to claim 1, wherein said charge adjuvant is a metallic soap.

7. A method according to claim 6 wherein the metallic soap is an aluminum soap.

8. A method according to claim 6, wherein said metallic soap comprises an aluminum stearate

9. A method according to claim 7 wherein the aluminum stearate comprises aluminum tri-stearate.

10. A method according to claim 1, wherein said dissolving is aided by heating to a temperature exceeding 120° C.

11. A method according to claim 1, wherein said dissolving is aided by heating to a temperature exceeding 130° C.

12. A method according to claim 1, wherein said dissolving is aided by heating to a temperature of no greater than 130° C.

13. A method according to claim 1 wherein and including cooling the dissolved charge adjuvant to a temperature below 60° C., prior to mixing it with the polymer.

14. A method according to claim 1 wherein the charge adjuvant has only limited solubility in the carrier liquid at 125° C.

15. A method according to claim 1 wherein the charge adjuvant is substantially insoluble in the carrier liquid at 25° C.

16. A method according to claim 1 wherein the charge adjuvant does not dissolve in the carrier liquid at a temperature at which it is mixed with the polymer, but remains dissolved therein, when dissolved therein at said mixing temperature, when dissolved at a higher temperature.

17. A method according to claim 1 wherein the charge adjuvant does not substantially dissolve in the carrier liquid at 40°, but remains dissolved therein, when dissolved at a higher temperature.

18. A method according to claim 1 wherein the charge adjuvant does not substantially dissolve in the carrier liquid at 60°, but remains dissolved therein, when dissolved at a higher temperature.

19. A method according to claim 1 wherein dissolving includes adding a surfactant to the solution of carrier liquid and charge adjuvant.

20. (canceled)

21. A method according to claim 1 wherein said mixing and grinding are performed in a same grinder or a same attritor.

22. A method according to claim 1 wherein said mixing is performed in a first vessel and wherein said grinding is performed in a second vessel.

23. A method according to claim 22 wherein said mixing is performed in a mixer without grinding media.

24. A method according to claim 21 wherein said grinding is performed in a grinder or an attritor.

25. A method according to claim 2, wherein said dissolving is aided by heating to a temperature exceeding 120° C.

26. A method according to claim 2, wherein said dissolving is aided by heating to a temperature exceeding 120° C.

27. A method according to claim 10 wherein and including cooling the dissolved charge adjuvant to a temperature below 60° C., prior to mixing it with the polymer.
